(19) United States
(12) Patent Application Publication
(10) Pub. No.: US 2026/0343331 A1
(43) Pub. Date: Oct. 29, 2026

(54) SWITCHING PERIOD LOCATION FOR TRANSMIT SWITCHING

(71) Applicant: QUALCOMM Incorporated, San Diego, CA (US)

(72) Inventors: Yiqing CAO, Beijing (CN); Peter GAAL, San Diego, CA (US); Bin HAN, Beijing (CN)

(21) Appl. No.: 19/103,650

(22) PCT Filed: Nov. 3, 2022
(86) PCT No.: PCT/CN2022/129403

§ 371 Date: Feb. 13, 2025

(51) Int. Cl. H04W 36/00; H04W 72/0453

(52) U.S. Cl. CPC H04W 36/0055; H04W 72/0453

(57) ABSTRACT

A user equipment (UE) identifies configuration information indicating respective frequency band(s) associated with a switching period for each of multiple switching case pairs, each of the respective frequency band(s) being one of frequency bands including more than two frequency bands for uplink, each of the multiple switching case pairs being associated with two switching cases of multiple switching cases, the multiple switching cases each indicating one or more of the frequency bands. The UE identifies a switching case pair from the multiple switching case pairs based on first frequency band(s) being switched to second frequency band(s), and associates a switching period with at least one frequency band indicated by the configuration information based on the identified switching case pair. The UE switches to the second frequency band(s) during the switching period associated with the at least one frequency band, and transmits uplink communications on the second frequency band(s).

### TECHNICAL FIELD

The technology discussed below relates generally to wireless communication systems, and more particularly, to associating a switching period for transmit switching with a frequency band configured for uplink transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, frequency bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

A UE transmitting on one frequency band may switch to transmitting on a different frequency band. A switching period may be associated with one of these two frequency bands. The location (e.g., frequency band) of the switching period may be configured.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method of wireless communication by a user equipment (UE) is disclosed. The method includes identifying configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, identifying a switching case pair from the plurality of switching case pairs based on one or more first frequency bands of the plurality of frequency bands being switched to one or more second frequency bands of the plurality of frequency bands, associating a switching period with at least one frequency band indicated by the configuration information based on the identified switching case pair, the at least one frequency band being at least one of the one or more first frequency bands or at least one of the one or more second frequency bands, switching from the one or more first frequency bands to the one or more second frequency bands during the switching period associated with the at least one frequency band, and transmitting a set of uplink communications on the one or more second frequency bands.

In another example, a UE for wireless communication is disclosed. The UE includes at least one processor, a transceiver communicatively coupled to the at least one processor, and a memory communicatively coupled to the at least one processor. The at least one processor may be configured to: identify configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, identify a switching case pair from the plurality of switching case pairs based on one or more first frequency bands of the plurality of frequency bands being switched to one or more second frequency bands of the plurality of frequency bands, associate a switching period with at least one frequency band indicated by the configuration information based on the identified switching case pair, the at least one frequency band being at least one of the one or more first frequency bands or at least one of the one or more second frequency bands, switch from the one or more first frequency bands to the one or more second frequency bands during the switching period associated with the at least one frequency band, and transmit a set of uplink communications on the one or more second frequency bands.

In another example, a non-transitory processor-readable storage medium having instructions for a UE thereon may be disclosed. The instructions, when executed by a processing circuit, cause the processing circuit to: identify configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, identify a switching case pair from the plurality of switching case pairs based on one or more first frequency bands of the plurality of frequency bands being switched to one or more second frequency bands of the plurality of frequency bands, associate a switching period with at least one frequency band indicated by the configuration information based on the identified switching case pair, the at least one frequency band being at least one of the one or more first frequency bands or at least one of the one or more second frequency bands, switch from the one or more first frequency bands to the one or more second frequency bands during the switching period associated with the at least one frequency band, and transmit a set of uplink communications on the one or more second frequency bands.

In a further example, a UE for wireless communication may be disclosed. The UE includes means for identifying configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, means for identifying a switching case pair from the plurality of switching case pairs based on one or more first frequency bands of the plurality of frequency bands being switched to one or more second frequency bands of the plurality of frequency bands, means for associating a switching period with at least one frequency band indicated by the configuration information based on the identified switching case pair, the at least one frequency band being at least one of the one or more first frequency bands or at least one of the one or more second frequency bands, means for switching from the one or more first frequency bands to the one or more second frequency bands during the switching period associated with the at least one frequency band, and means for transmitting a set of uplink communications on the one or more second frequency bands

In one example, a method of wireless communication by a network entity is disclosed. The method includes . . .

In another example, a network entity for wireless communication is disclosed. The network entity includes at least one processor, a transceiver communicatively coupled to the at least one processor, and a memory communicatively coupled to the at least one processor. The at least one processor may be configured to: transmit, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, wherein a switching case pair is identified from the plurality of switching case pairs based on one or more first frequency bands of the plurality of frequency bands being switched to one or more second frequency bands of the plurality of frequency bands, and receive a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands.

In another example, a non-transitory processor-readable storage medium having instructions for a network entity thereon may be disclosed. The instructions, when executed by a processing circuit, cause the processing circuit to: transmit, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, wherein a switching case pair is identified from the plurality of switching case pairs based on one or more first frequency bands of the plurality of frequency bands being switched to one or more second frequency bands of the plurality of frequency bands, and receive a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands.

In a further example, a network entity for wireless communication may be disclosed. The network entity includes means for transmitting, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, where a switching case pair is identified from the plurality of switching case pairs based on one or more first frequency bands of the plurality of frequency bands being switched to one or more second frequency bands of the plurality of frequency bands, and means for receiving a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands.

These and other aspects of the disclosure will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some embodiments.

FIG. 5 is an example diagram illustrating a UE with three or more frequency bands configured for UL transmission to a network entity when, according to some aspects.

FIG. 6 is an example diagram illustrating a table showing an example of multiple switching cases, according to some aspects.

FIG. 7 is an example diagram illustrating a table showing an example of a configuration information, according to some aspects.

FIG. 8 is a block diagram conceptually illustrating an example of a hardware implementation for a scheduled entity or a user equipment according to some aspects.

FIG. 9 is a flow chart illustrating an exemplary process for wireless communication according to some aspects.

FIG. 10 is a block diagram conceptually illustrating an example of a hardware implementation for a scheduling entity or a network entity according to some aspects.

FIG. 11 is a flow chart illustrating an exemplary process for wireless communication according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

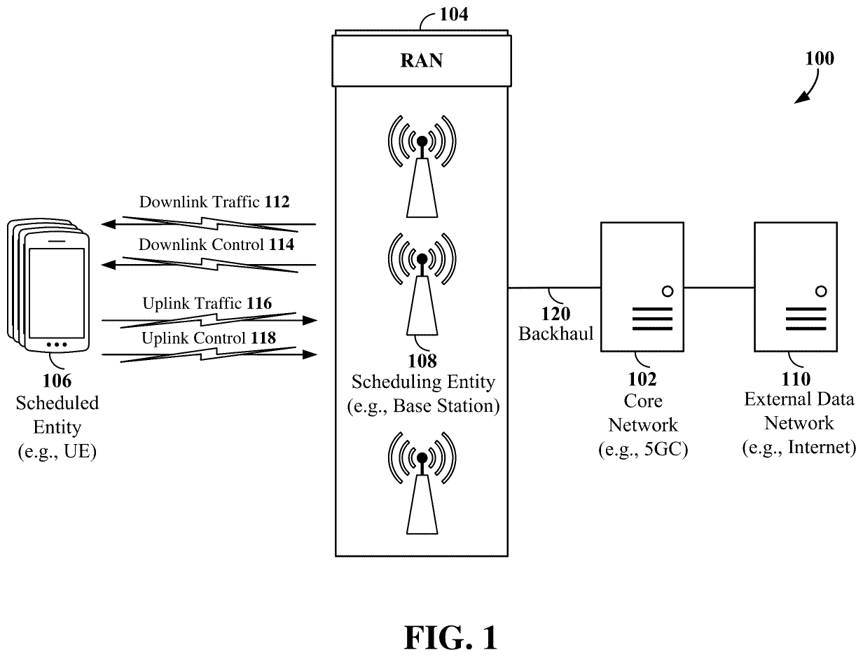

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

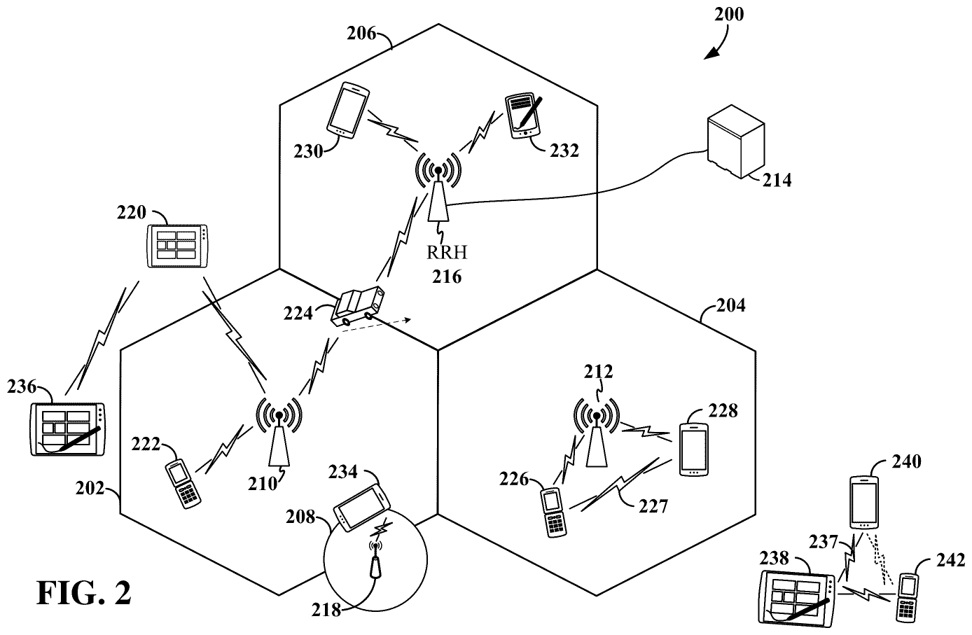

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

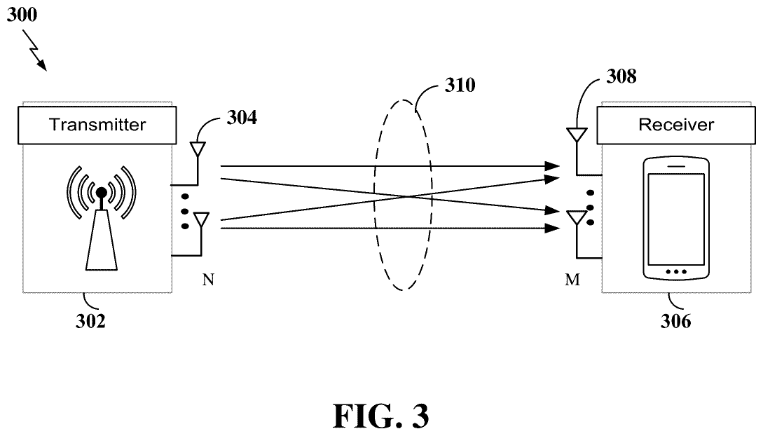

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C-RS sequences for each layer to provide for multi-layer channel estimation. From the CSI-RS, the UE may measure the channel quality across layers and resource blocks and feed back the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

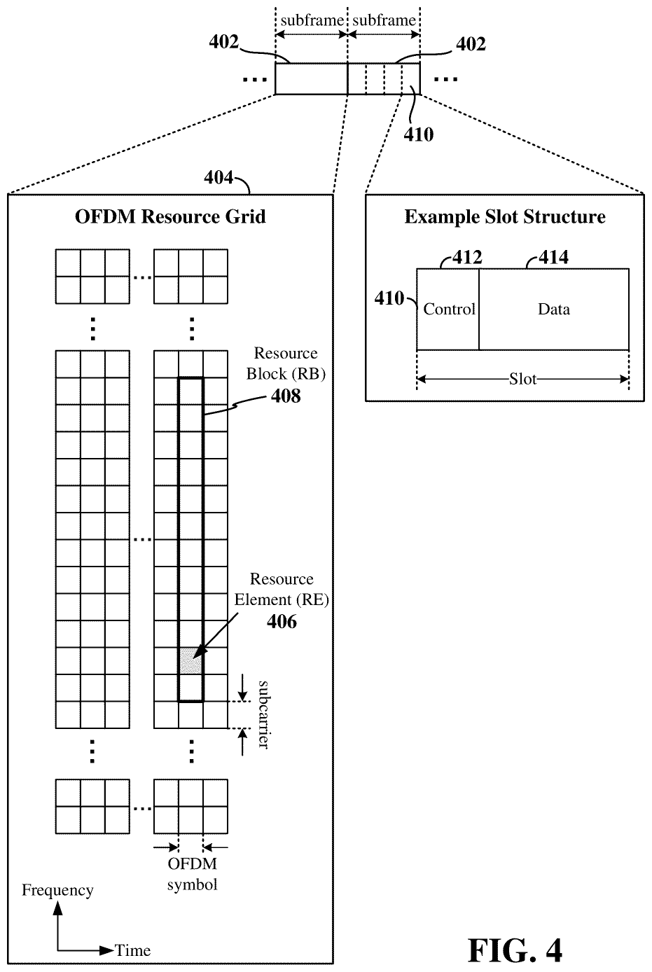

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

A UE may be configured to switch between frequency bands for uplink transmission. For example, a UE may switch between a first frequency band associated with a first cell and a second frequency band associated with a second cell. In a first scenario, the UE may receive, from a network entity, an uplink grant or a radio resource control (RRC) configuration for uplink transmission. In this case, the uplink grant or the RRC configuration may specify a dynamic transmit carrier switching mode for the UE, in which the UE dynamically switches between frequency bands. In a second scenario, the UE may receive, from a network, an indication of a pair of frequency bands (e.g., out of a group of configured frequency bands) via downlink control information (DCI) or a medium access control (MAC) control element (CE). In this case, the UE may dynamically switch between the two frequency bands based at least in part on the DCI or MAC CE. In a third scenario, the UE may determine an anchor frequency band (e.g., out of a group of configured frequency bands) and may dynamically switch between the anchor frequency band and a single non-anchor frequency band (or from the single non-anchor frequency band to the anchor frequency band).

In these two-frequency band switching scenarios, the UE may be configured with a two-frequency band switching period. For example, the UE may receive RRC signaling from the network entity indicating a periodicity or switching period for switching between the two frequency bands. The switching period may be associated with a carrier. The association of the switching period with the carrier may be based at least in part on an information element uplinkTxSwitching-r16, which may have a first parameter for an uplink transmit switching period location (uplinkTxSwitchingPeriodLocation-r16) and a second parameter for an uplink transmit switching period carrier (uplinkTxSwitchingCarrier-r16). The first parameter indicates whether an uplink transmit switching period is configured in a carrier enumerated by the second parameter. In a case of inter-band uplink carrier aggregation, a network entity may configure the first parameter to ‘TRUE’ for an uplink carrier that is involved in dynamic uplink transmit switching and ‘FALSE’for other carriers.

In a scenario where the UE is configured with three or more frequency bands for UL transmit switching, the following three approaches may be utilized. In a first approach, the UE may perform dynamic UL transmit switching on any one of the three or more frequency bands configured for UL transmission, based on UL scheduling, e.g., via a UL grant and/or an RRC configuration for UL transmission. The UL grant and/or the RRC configuration for UL transmission may trigger the UL transmit switching from one frequency band to another frequency band. Hence, for example, even if three or more frequency bands are configured for UL transmission, the UE may switch from one of the configured frequency bands to another one of the configured frequency bands, based on the UL scheduling.

In a second approach, a network node may indicate two frequency bands out of the configured bands via DCI or a MAC-CE, where a number of the configured bands is three or more. Subsequently, the UE may perform the dynamic UL transmit switching between the indicated two frequency bands, as discussed above and as discussed in 3GPP Release 17. For example, the UE may first select two frequency bands out of the configured frequency bands based on DCI or MAC-CE indicating the two frequency bands, and then may trigger the UL transmit switching between the selected two frequency bands (e.g., via a UL grant and/or an RRC configuration message).

In a third approach, one anchor band may be selected among three or more configured frequency bands, and dynamic UL transmit switching can be performed only from the anchor band to a non-anchor band and from a non-anchor band to the anchor band. For example, to switch from a first non-anchor band to a second non-anchor band, the UE may switch from the first non-anchor band to an anchor band, and then switch from the anchor band to the second non-anchor band. The UE may select an anchor band from three or more configured frequency bands via DCI or a MAC-CE or an RRC configuration message. The UL transmit switching may be triggered by a UL grant and/or an RRC configuration.

As discussed above, for uplink transmit switching with only two configured frequency bands, the switching period may be configured at one of the two frequency bands by the network via an RRC signaling. However, if three or more frequency bands are configured for uplink transmit switching, the switching periods should be configured on one of the three or more configured frequency bands participating the UL transmit switching. Hence, an approach to configure a frequency band to associate with a switching period is desired when three or more frequency bands are configured for UL transmission.

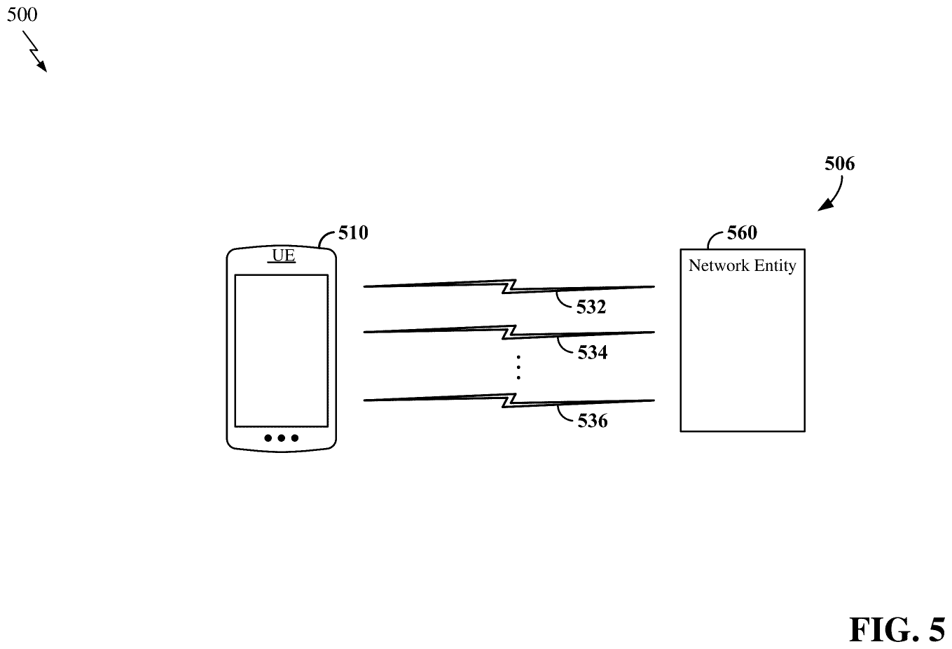

FIG. 5 is an example diagram 500 illustrating a UE configured with three or more frequency bands for UL transmission to a network entity, according to some aspects. As shown in FIG. 5, a UE 510 may be configured with three or more frequency bands 532, 534, 536 for UL transmission. The UE 510 may utilize one or more of the configured frequency bands 532, 534, 536 for UL transmission to a network entity 560. The switching between one or more first frequency bands to one or more second frequency bands is more complicated when three or more frequency bands are configured for UL transmission. For example, there are more possible combinations for switching pairs of the one or more first frequency bands and the one or more second frequency bands. In one example, the UE 510 may switch from the frequency band 532 to the frequency bands 534 and 536. In another example, the UE 510 may switch from the frequency bands 532 and 534 to two frequency bands 534 and 536. In another example, the UE 510 may switch from the frequency bands 532 and 534 to the frequency band 536. There may exist more potential combinations for switching pairs than these examples.

Accordingly, when three or more frequency bands are configured for UL transmission, configuration information may be set to indicate one or more particular frequency band(s) out of the configured frequency bands to be associated with a switching period depending on which of the configured frequency bands are used before switching and which of the configured frequency bands are used after switching. According to some aspects of the disclosure, the configuration information may indicate one or more particular frequency band(s) to be associated with a switching period, based on a particular switching case pair that indicates which frequency band(s) are switched to which frequency band(s). In other words, the configuration information may indicate respective frequency band(s) associated with a switching period for each switching case pair of multiple switching case pairs, each of the respective frequency band(s) being one of frequency bands including more than two frequency bands configured for UL transmission. Here, each of the switching case pairs is associated with two switching cases of multiple switching cases, and each of the multiple switching cases indicates one or more of the frequency bands for UL transmission. The UE (e.g., UE 510) may identify the configuration information. In an aspect, the UE may identify the configuration information after receiving the configuration information from a network entity (e.g., network entity 560). In this aspect, the configuration information may be transmitted to the UE via an RRC message or a MAC CE. In another aspect, the UE may identify the configuration information that is preconfigured at the UE. For example, in this aspect, the configuration information may be preloaded at the UE during a manufacturing stage of the UE. In some aspects, the network entity may also be preconfigured with the configuration information.

In some aspects, one or more transmit chains may be associated with at least one of the one or more of the configured frequency bands indicated by each of the multiple switching cases. In some aspects, in addition to indicating one or more of the configured frequency bands for UL transmission, each of the multiple switching cases may further indicate one or more respective numbers of transmit chains respectively associated with each of the one or more of the configured frequency bands.

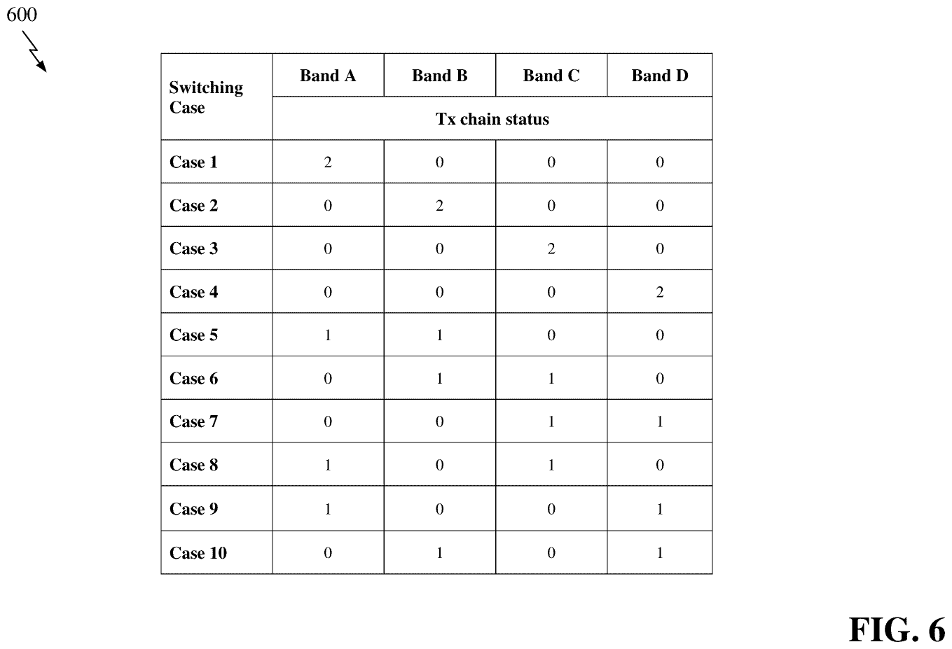

FIG. 6 is an example diagram 600 illustrating a table showing an example of multiple switching cases, according to some aspects. In the example shown in FIG. 6, for four frequency bands including Band A, Band B, Band C, and Band D are configured to UL transmission and two available transmit chains, there may be 10 different switching cases. Each switching case indicates one or more frequency bands for UL transmission. For example, according to the FIG. 6, switching case 1 indicates that Band A for UL transmission. In another example, according to the FIG. 6, switching case 6 indicates Band B and Band C for UL transmission.

As shown in FIG. 6, a particular switching case indicates one or more frequency bands for UL transmission. In addition, as shown in FIG. 6, the particular switching case may further indicate a respective number of transmit chains associated with each of the one or more frequency bands indicated by the particular switching case. For example, in FIG. 6, switching case 1 indicates Band A for UL transmissions and further indicates 2 for the number of transmit chains for Band A. In another example, in FIG. 6, switching case 6 indicates Band B and Band C for UL transmission and further indicates 1 for the number of transmit chains for Band B and 1 for the number of transmit chains for Band C.

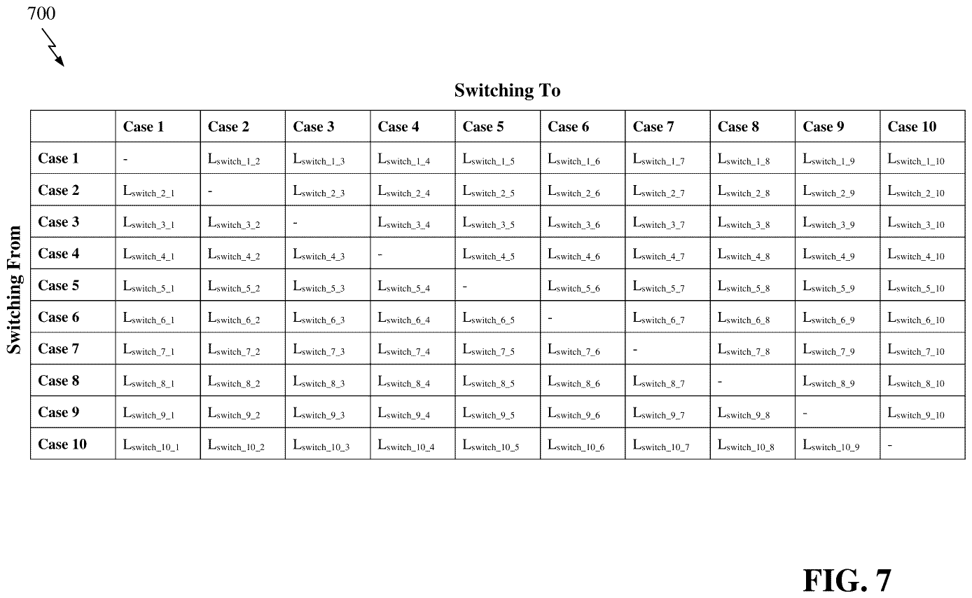

FIG. 7 is an example diagram 700 illustrating a table showing an example of a configuration information, according to some aspects. In one example, the switching cases of FIG. 6 may be utilized to generate the configuration information of FIG. 7. The table in FIG. 7 shows various switching period locations depending on a switching case pair, such as a switching case to switch from and a switching case to switch to. Each of the switching period locations indicates a respective location of the switching period, by indicating at least one particular frequency band for the identified switching case pair. For example, L_{switch_1_2} indicates a switching period location when switching from the switching case 1 to the switching case 2. Referring to FIG. 6, the switching case 1 indicates Band A and 2 transmit chains for Band A, and the switching case 2 indicates Band B and 2 transmit chains for Band B. Hence, L_{switch_1_2} may be set to indicate either Band A or Band B as a location for a switching period. In another example, L_{switch_5_6} indicates a switching period location when switching from the switching case 5 to the switching case 6. Referring to FIG. 6, the switching case 5 indicates Band A and 1 transmit chain for Band A as well as Band B and 1 transmit chain for Band B, while the switching case 6 indicates Band B and 1 transmit chain for Band B as well as Band C and 1 transmit chain for Band C. Hence, in one example, L_{switch_5_6} may indicate one of Band A, Band B, and Band C as a location for a switching period. In another example, L_{switch_5_6} may indicate Band A and Band B or Band B and Band C as two locations for a switching period.

The UE may determine to switch from one or more first frequency bands of the frequency bands configured for UL transmission to one or more second frequency bands of the frequency bands. In this case, the UE may identify a switching case pair from the multiple switching case pairs based on the one or more first frequency bands being switched to the one or more second frequency bands. For example, referring to FIG. 6, if the switching occurs from Band A, Band B to Band C, Band D, then the switching case pair may be identified as the switching case 5 to the switching case 7.

After identifying the switching case pair, the UE may associate a switching period with at least one frequency band indicated by on the configuration information based on the identified switching case pair. Here, the at least one frequency band may be at least one of the one or more first frequency bands or at least one of the one or more second frequency bands. During the switching period associated with the at least one frequency band, the UE may switch from the one or more first frequency bands to the one or more second frequency bands. For example, referring to FIG. 6 and FIG. 7, if the switching occurs from Band A and Band B to Band B and Band C and thus the identified switching pair is the switching case 5 to the switching case 6, then based on the switching pair of the switching case 5 to the switching case 6, the configuration information may indicate at least one frequency band by L_{switch_5_6}. The at least one frequency in this example may be at least one of Band A, Band B, or Band C.

In some aspects, the UE identifying the switching case pair from the multiple switching case pairs may identify the switching case pair from the multiple switching case pairs based on the one or more first frequency bands being switched to the one or more second frequency bands and further based on one or more numbers of transmit chains respectively associated with the one or more first frequency bands and one or more numbers of transmit chains respectively associated with the one or more second frequency bands. For example, referring to FIG. 6, if the switching occurs from Band A with 2 transmit chain to Band B with 1 transmit chain, Band C with 1 transmit chain, then the switching case pair may be identified as the switching case 1 to the switching case 6. In this example, referring to FIG. 7, the configuration information may indicate at least one frequency band by L_{switch_1_6}, based on the identified switching pair of the switching case 1 to the switching case 6. Thus, the UE may associate the switching period with the at least one frequency band indicated by L_{switch_1_6} of the configuration information based on the identified switching case pair. In another example, referring to FIG. 6, if the switching occurs from Band A with 1 transmit chain, Band B with 1 transmit chain to Band C with 1 transmit chain, Band D with 1 transmit chain, then the switching case pair may be identified as the switching case 5 to the switching case 7. In this example, referring to FIG. 7, the configuration information may indicate at least one frequency band by L_{switch_5_7}, based on the identified switching pair of the switching case 5 to the switching case 7.

In some aspects, while switching from the one or more first frequency bands to the one or more second frequency bands, the UE may refrain from transmitting on the at least one frequency band with which the switching period is associated during the switching period. During this time, the network entity may refrain from receiving on the at least one frequency band with which the switch period is associated. If the UE performs a switch of frequency band(s), the UE may utilize an outage time to allow a transmit chain to tune from one frequency band to another frequency band. After the UE receives an UL grant and/or an RRC message that triggers switching, the switching period begins and there is no UL transmission during this switching period. The switching period should be long enough to allow the switching to be completed.

After switching to the one or more second frequency bands, the UE may transmit a set of UL communications on the one or more second frequency bands. In the example above where the UE switches to Band B and Band C, the UE may transmit a set of UL communications on Band B and Band C.

In some aspects, the one or more respective frequency bands associated with the switching period for each of the multiple switching case pairs may include a single frequency band indicated by 2 bits. For example, referring to FIG. 7, each of the switching period locations (e.g., L_{switch_1_2}, L_{switch_1_3}, . . . L_{switch_10_9}) in the configuration information may indicate a respective single frequency band associated with the switching period for a particular switching case pair and may be indicated by 2 bits. In the example shown in FIG. 7, there are 90 different switching period locations. In one aspect, referring to the example in FIG. 7, a total number of bits needed to indicate each single frequency band for each of the 90 switching case pairs may be 2×90=180 bits.

In some aspects, when the switching is performed between the same band pair, the switching period may be associated with a single frequency band for the same band pair. For example, if the switching is performed between one or more first frequencies and one or more second frequencies, the switching period may be associated with a particular frequency band for the band pair of the one or more first frequencies and the one or more second frequencies, regardless of whether the switching occurs from the one or more first frequencies to the one or more second frequencies or from the one or more first frequencies to the one or more second frequencies. For example, referring to the example in FIG. 7, L_{switch_1_2} and L_{switch_2_1} are directed to the same band pairs, L_{switch_1_3} and L_{switch_3_3} are directed to the same band pairs, and L_{switch_2_3} and L_{switch_3_2} are directed to the same band pairs, and so on. Therefore, in this aspect, referring to the example in FIG. 7, there are 45 different band pairs, and thus a total number of bits needed to indicate each single frequency band for each of the 45 different band pairs may be 2×45=90 bits.

In some aspects, the one or more respective frequency bands associated with the switching period for each of the switching case pairs may include two or more frequency bands indicated by 4 bits. In the example shown in FIG. 7, there are 90 different switching period locations, as explained above. Hence, referring to the example in FIG. 7, a total number of bits needed to indicate respective two or more frequency bands for each of the 90 switching case pairs may be 4×90=360 bits.

When only two frequency bands are configured for UL transmission, one of the two frequency bands may be an anchor band and the other one of the two frequency bands may be a non-anchor band, and either the anchor band or the non-anchor band may be associated with a switching period. However, when three or more frequency bands are configured for UL transmission and one or more of the configured frequency bands are anchor bands, an approach to associate a switching period with one or more configured frequency bands is desired.

In some cases, when the UE is about to switch from the one or more first frequency bands to the one or more second frequency bands, the one or more first frequency bands and the one or more second frequency bands may include the one or more first frequency bands including two first frequency bands and/or the one or more second frequency bands including two second frequency bands. For example, when three or more frequency bands are configured for UL transmission, the UE may switch from a single frequency band to two frequency bands, or from two frequency bands to a single frequency band, or from two frequency bands to two frequency bands. In this case, if the two first frequency bands are anchor bands and/or the two second frequency bands are non-anchor bands, or if the two first frequency bands are non-anchor bands and/or the two second frequency bands are anchor bands, the UE may associate the switching period either with at least one of the two first frequency bands or with at least one of the two second frequency bands. For example, if the UE is about to switch from a single first frequency band to two second frequency bands and the two second frequency bands are configured as either anchor bands or non-anchor bands, the switching period may be associated with at least one of the two second frequency bands. In another example, if the UE is about to switch from two first frequency bands to a single second frequency band and the two first frequency bands are configured as either anchor bands or non-anchor bands, the switching period may be associated with at least one of the two first frequency bands. Also, in another example, if the UE is about to switch from two first frequency bands to two second frequency bands and the two first frequency bands are configured as either anchor bands or non-anchor bands, the switching period may be associated either with at least one of the two first frequency bands or with at least one of the two second frequency bands. Yet, in another example, if the UE is about to switch from two first frequency bands to two second frequency bands and the two second frequency bands are configured as either anchor bands or non-anchor bands, the switching period may be associated either with at least one of the two first frequency bands or with at least one of the two second frequency bands.

In some aspects, the UE may receive a message (e.g., an RRC message from the network entity) indicating either (a) the two first frequency bands being anchor bands and/or the two second frequency bands being non-anchor bands, or (b) the two first frequency bands being non-anchor bands and/or the two second frequency bands being anchor bands. Based on this message, the UE may configure the two first frequency bands to be either anchor bands or non-anchor bands, and/or may configure the two second frequency bands to be anchor bands or non-anchor bands. In this aspect, after receiving the message, the UE may associate the switching period based on one of the following approaches.

In a first approach, both of the two frequency bands configured to be either anchor bands or non-anchor bands may be associated with a switching period. Hence, according to the first approach, the UE may associate the switching period either with both of the two first frequency bands (e.g., if the two first frequency bands are configured to be anchor bands or non-anchor bands) or with both of the two second frequency bands (e.g., if the two second frequency bands are configured to be anchor bands or non-anchor bands).

In a second approach, among the two frequency bands configured to be either anchor bands or non-anchor bands, a frequency band with a lower subcarrier spacing may be associated with a switching period. Hence, according to the second approach, the UE may associate the switching period either with one of the two first frequency bands that has a lower subcarrier spacing among the two first frequency bands (e.g., if the two first frequency bands are configured to be anchor bands or non-anchor bands) or with one of the two second frequency bands that has a lower subcarrier spacing among the two second frequency bands (e.g., if the two second frequency bands are configured to be anchor bands or non-anchor bands).

In a third approach, among the two frequency bands configured to be either anchor bands or non-anchor bands, a frequency band with a greater subcarrier spacing may be associated with a switching period. Hence, according to the third approach, the UE may associate the switching period either with one of the two first frequency bands that has a greater subcarrier spacing among the two first frequency bands (e.g., if the two first frequency bands are configured to be anchor bands or non-anchor bands) or with one of the two second frequency bands that has a greater subcarrier spacing among the two second frequency bands (e.g., if the two second frequency bands are configured to be anchor bands or non-anchor bands).

In a fourth approach, among the two frequency bands configured to be either anchor bands or non-anchor bands, a frequency band with a higher frequency may be associated with a switching period. Hence, according to the fourth approach, the UE may associate the switching period either with one of the two first frequency bands that has a lower frequency among the two first frequency bands or with one of the two second frequency bands that has a lower frequency among the two second frequency bands (e.g., if the two second frequency bands are configured to be anchor bands or non-anchor bands).

In a fifth approach, among the two frequency bands configured to be either anchor bands or non-anchor bands, a frequency band with a lower frequency may be associated with a switching period. Hence, according to the fifth approach, the UE may associate the switching period either with one of the two first frequency bands that has a higher frequency among the two first frequency bands (e.g., if the two first frequency bands are configured to be anchor bands or non-anchor bands) or with one of the two second frequency bands that has a higher frequency among the two second frequency bands (e.g., if the two second frequency bands are configured to be anchor bands or non-anchor bands).

In a sixth approach, among the two frequency bands configured to be either anchor bands or non-anchor bands, a frequency band with a smaller bandwidth may be associated with a switching period. Hence, according to the fifth approach, the UE may associate the switching period either with one of the two first frequency bands that has a lower bandwidth among the two first frequency bands or with one of the two second frequency bands that has a lower bandwidth among the two second frequency bands.

In some aspects, instead of receiving a message indicating certain frequency bands are anchor bands or non-anchor bands, the UE may be pre-configured to set particular frequency bands to be anchor bands or non-anchor bands. When the UE is pre-configured with anchor bands or non-anchor bands, in some aspects, if switching from a single first frequency band to two second frequency bands, the switching period may be associated with the single first frequency band. When the UE is pre-configured with anchor bands or non-anchor bands, in some aspects, if switching from two first frequency bands to a single second frequency band, the switching period may be associated with the single second frequency band. Hence, for switching from the two first frequency bands to a single second frequency band or for switching from a single first frequency band to two second frequency bands, the UE may associate the switching period with the single second frequency band or the single first frequency band. When the UE is pre-configured with anchor bands or non-anchor bands, in some aspects, if switching from two first frequency bands to two second frequency bands, either the two first frequency bands or the two second frequency bands may be associated with the switching period. Hence, for switching from the two first frequency bands to the two second frequency bands, the UE may associate the switching period with the two first frequency bands or the two second frequency bands.

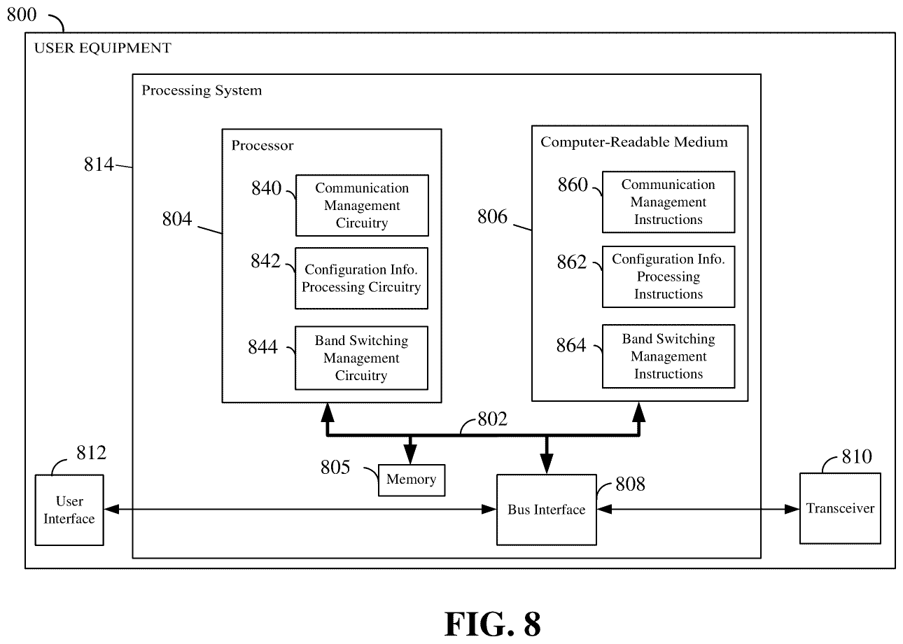

FIG. 8 is a block diagram illustrating an example of a hardware implementation for a scheduled entity or a UE 800 employing a processing system 814. For example, the UE 800 may be a UE as illustrated in any one or more of FIGS. 1, 2, 3, and/or 5. In another example, the UE 800 may be a UE as illustrated in any one or more of FIGS. 1, 2, 3, and/or 5.

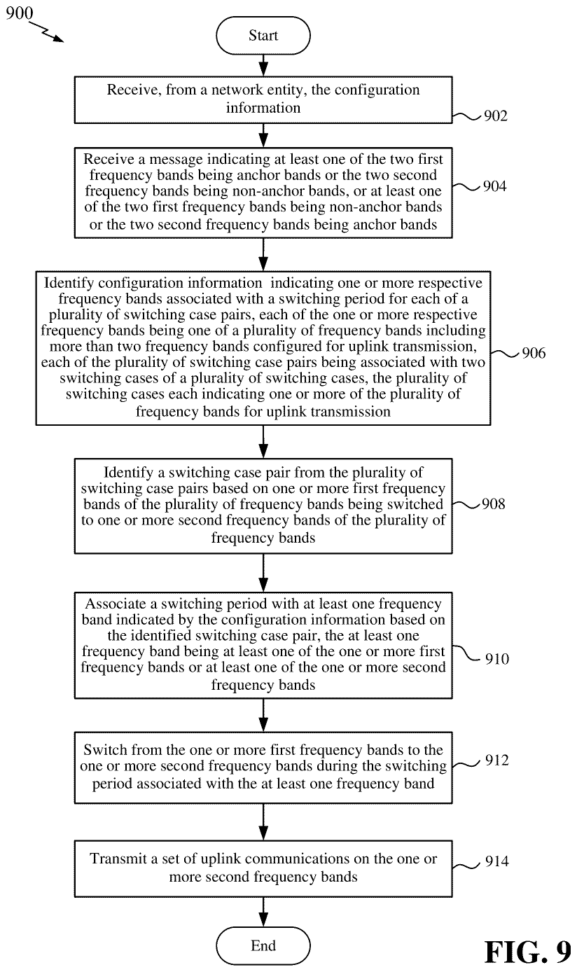

The UE 800 may be implemented with a processing system 814 that includes one or more processors 804. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 800 may be configured to perform any one or more of the functions described herein. That is, the processor 804, as utilized in a UE 800, may be used to implement any one or more of the processes and procedures described below and illustrated in FIG. 9.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits including one or more processors (represented generally by the processor 804), a memory 805, and computer-readable media (represented generally by the computer-readable storage medium 806). The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a communication interface or means for communicating with various other apparatus over a transmission medium. Depending upon the nature of the apparatus, a user interface 812 (e.g., keypad, display, speaker, microphone, joystick) may also be provided.

In some aspects of the disclosure, the processor 804 may include communication management circuitry 840 configured for various functions, including, for example, receiving the configuration information. For example, the communication management circuitry 840 may be configured to implement one or more of the functions described below in relation to FIG. 9, including, e.g., block 902.

In some aspects, the communication management circuitry 840 may be configured for various functions, including, for example, receiving a message indicating at least one of: the two first frequency bands being anchor bands or the two second frequency bands being non-anchor bands, or at least one of the two first frequency bands being non-anchor bands or the two second frequency bands being anchor bands. For example, the communication management circuitry 840 may be configured to implement one or more of the functions described below in relation to FIG. 9, including, e.g., block 904.

In some aspects, the communication management circuitry 840 may be configured for various functions, including, for example, transmitting a set of uplink communications on the one or more second frequency bands. For example, the communication management circuitry 840 may be configured to implement one or more of the functions described below in relation to FIG. 9, including, e.g., block 914.

In some aspects of the disclosure, the processor 804 may include configuration information processing circuitry 842 configured for various functions, including, for example, identifying the configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission. For example, the configuration information processing circuitry 842 may be configured to implement one or more of the functions described below in relation to FIG. 9, including, e.g., block 906.

In some aspects of the disclosure, the processor 804 may include band switching management circuitry 844 configured for various functions, including, for example, identifying a switching case pair from the plurality of switching case pairs based on one or more first frequency bands of the plurality of frequency bands being switched to one or more second frequency bands of the plurality of frequency bands. For example, the band switching management circuitry 844 may be configured to implement one or more of the functions described below in relation to FIG. 9, including, e.g., block 908.

In some aspects, the band switching management circuitry 844 may be configured for various functions, including, for example, associating a switching period with at least one frequency band indicated by the configuration information based on the identified switching case pair, the at least one frequency band being at least one of the one or more first frequency bands or at least one of the one or more second frequency bands. For example, the band switching management circuitry 844 may be configured to implement one or more of the functions described below in relation to FIG. 9, including, e.g., block 910.

In some aspects, the band switching management circuitry 844 may be configured for various functions, including, for example, switching from the one or more first frequency bands to the one or more second frequency bands during the switching period associated with the at least one frequency band. For example, the band switching management circuitry 844 may be configured to implement one or more of the functions described below in relation to FIG. 9, including, e.g., block 912.

The processor 804 is responsible for managing the bus 802 and general processing, including the execution of software stored on the computer-readable storage medium 806. The software, when executed by the processor 804, causes the processing system 814 to perform the various functions described below for any particular apparatus. The computer-readable storage medium 806 and the memory 805 may also be used for storing data that is manipulated by the processor 804 when executing software.

One or more processors 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 806. The computer-readable storage medium 806 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 806 may reside in the processing system 814, external to the processing system 814, or distributed across multiple entities including the processing system 814. The computer-readable storage medium 806 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In some aspects of the disclosure, the computer-readable storage medium 806 may include communication management software/instructions 860 configured for various functions, including, for example, receiving the configuration information. For example, the communication management software/instructions 860 may be configured to implement one or more of the functions described below in relation to FIG. 9, including, e.g., block 902.

In some aspects, the communication management software/instructions 860 may be configured for various functions, including, for example, receiving a message indicating at least one of: the two first frequency bands being anchor bands or the two second frequency bands being non-anchor bands, or at least one of the two first frequency bands being non-anchor bands or the two second frequency bands being anchor bands. For example, the communication management software/instructions 860 may be configured to implement one or more of the functions described below in relation to FIG. 9, including, e.g., block 904.

In some aspects, the communication management software/instructions 860 may be configured for various functions, including, for example, transmitting a set of uplink communications on the one or more second frequency bands. For example, the communication management software/instructions 860 may be configured to implement one or more of the functions described below in relation to FIG. 9, including, e.g., block 914.

In some aspects of the disclosure, the computer-readable storage medium 806 may include configuration information processing software/instructions 862 configured for various functions, including, for example, identifying the configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission. For example, the configuration information processing software/instructions 862 may be configured to implement one or more of the functions described below in relation to FIG. 9, including, e.g., block 906.

In some aspects of the disclosure, the computer-readable storage medium 806 may include band switching management software/instructions 864 configured for various functions, including, for example, identifying a switching case pair from the plurality of switching case pairs based on one or more first frequency bands of the plurality of frequency bands being switched to one or more second frequency bands of the plurality of frequency bands. For example, the band switching management software/instructions 864 may be configured to implement one or more of the functions described below in relation to FIG. 9, including, e.g., block 908.

In some aspects, the band switching management software/instructions 864 may be configured for various functions, including, for example, associating a switching period with at least one frequency band indicated by the configuration information based on the identified switching case pair, the at least one frequency band being at least one of the one or more first frequency bands or at least one of the one or more second frequency bands. For example, the band switching management software/instructions 864 may be configured to implement one or more of the functions described below in relation to FIG. 9, including, e.g., block 910.

In some aspects, the band switching management software/instructions 864 may be configured for various functions, including, for example, switching from the one or more first frequency bands to the one or more second frequency bands during the switching period associated with the at least one frequency band. For example, the band switching management software/instructions 864 may be configured to implement one or more of the functions described below in relation to FIG. 9, including, e.g., block 912.

FIG. 9 is a flow chart illustrating an exemplary process 900 for wireless communication in accordance with some aspects of the present disclosure. As described below, some or all illustrated features may be omitted in a particular implementation within the scope of the present disclosure, and some illustrated features may not be required for implementation of all embodiments. In some examples, the process 900 may be carried out by the UE 800 illustrated in FIG. 8. In some examples, the process 900 may be carried out by any suitable apparatus or means for carrying out the functions or algorithm described below.

At block 902, in some aspects, the UE 800 may receive, from a network entity, the configuration information. For example, the communication management circuitry 840 shown and described above in connection with FIG. 8 may provide means for receiving the configuration information.

At block 904, in some aspects, the UE 800 may receive a message indicating at least one of: the two first frequency bands being anchor bands or the two second frequency bands being non-anchor bands, or at least one of the two first frequency bands being non-anchor bands or the two second frequency bands being anchor bands. For example, the communication management circuitry 840 shown and described above in connection with FIG. 8 may provide means for receiving the message.

At block 906, the UE 800 may identify the configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, For example, the configuration information processing circuitry 842 shown and described above in connection with FIG. 8 may provide means for identifying the configuration information.

At block 908, the UE 800 may identify a switching case pair from the plurality of switching case pairs based on one or more first frequency bands of the plurality of frequency bands being switched to one or more second frequency bands of the plurality of frequency bands. For example, the band switching management circuitry 844 shown and described above in connection with FIG. 8 may provide means for identifying the switching case pair.

At block 910, the UE 800 may associate a switching period with at least one frequency band indicated by the configuration information based on the identified switching case pair, the at least one frequency band being at least one of the one or more first frequency bands or at least one of the one or more second frequency bands. For example, the band switching management circuitry 844 shown and described above in connection with FIG. 8 may provide means for associating the switching period with the at least one frequency band.

At block 912, the UE 800 may switch from the one or more first frequency bands to the one or more second frequency bands during the switching period associated with the at least one frequency band. For example, the band switching management circuitry 844 shown and described above in connection with FIG. 8 may provide means for switching.

At block 914, the UE 800 may transmit a set of uplink communications on the one or more second frequency bands. For example, the communication management circuitry 840 shown and described above in connection with FIG. 8 may provide means for transmitting the set of uplink communications.

In one configuration, the UE 800 for wireless communication includes means for identifying configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, means for identifying a switching case pair from the plurality of switching case pairs based on one or more first frequency bands of the plurality of frequency bands being switched to one or more second frequency bands of the plurality of frequency bands, means for associating a switching period with at least one frequency band indicated by the configuration information based on the identified switching case pair, the at least one frequency band being at least one of the one or more first frequency bands or at least one of the one or more second frequency bands, means for switching from the one or more first frequency bands to the one or more second frequency bands during the switching period associated with the at least one frequency band, and means for transmitting a set of uplink communications on the one or more second frequency bands. In some aspects, the UE 800 may further include means for receiving, from a network entity, the configuration information. In some aspects, the UE 800 may further include means for receiving a message indicating at least one of the two first frequency bands being anchor bands or the two second frequency bands being non-anchor bands, or at least one of the two first frequency bands being non-anchor bands or the two second frequency bands being anchor bands.

In one aspect, the aforementioned means may be the processor(s) 804 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, 3, and/or 5, and utilizing, for example, the processes and/or algorithms described herein in relation to FIG. 9.

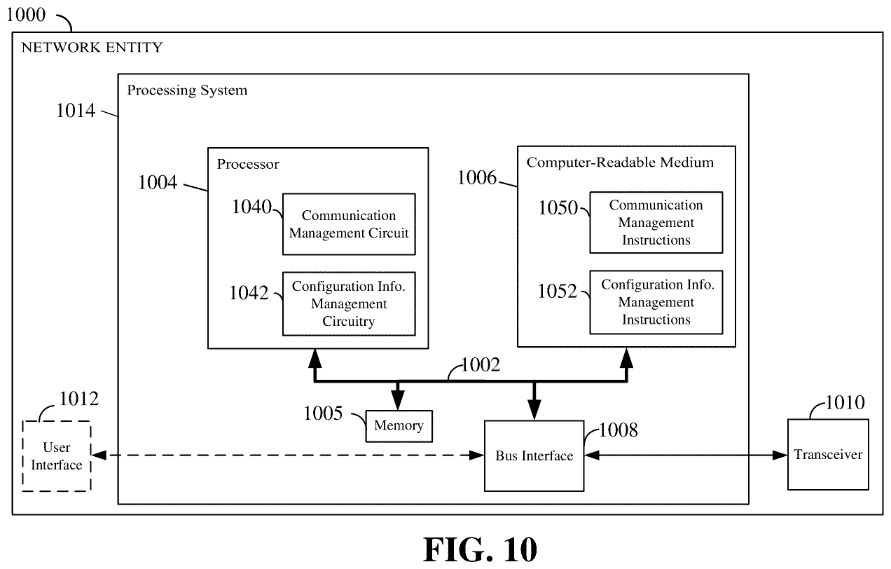

FIG. 10 is a conceptual diagram illustrating an example of a hardware implementation for an exemplary scheduling entity or a network entity 1000 employing a processing system 1014. In accordance with various aspects of the disclosure, an element, or any portion of an element, or any combination of elements may be implemented with a processing system 1014 that includes one or more processors 1004. For example, the network entity 1000 may be a network entity or a bases station as illustrated in any one or more of FIGS. 1, 2, 3, and/or 5.

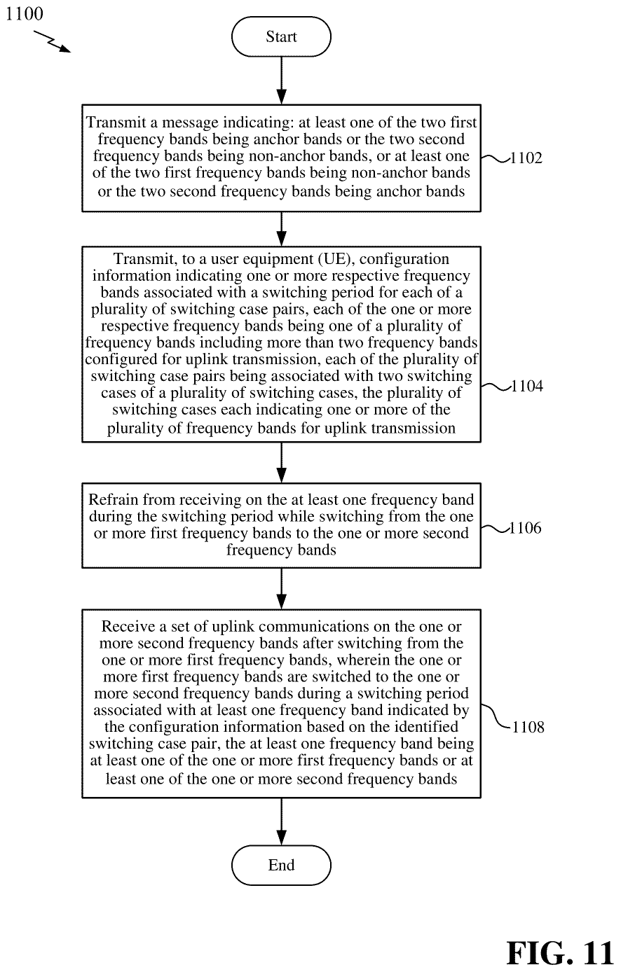

The processing system 1014 may be substantially the same as the processing system 714 illustrated in FIG. 7, including a bus interface 1008, a bus 1002, memory 1005, a processor 1004, and a computer-readable storage medium 1006. Furthermore, the network entity 1000 may include a user interface 1012 and a transceiver 1010 substantially similar to those described above in FIG. 8. That is, the processor 1004, as utilized in a network entity 1000, may be used to implement any one or more of the processes described below and illustrated in FIG. 11. Of course, such a user interface 1012 is optional, and may be omitted in some examples, such as a base station.

In some aspects of the disclosure, the processor 1004 may include communication management circuitry 1040 configured for various functions, including, for example, transmitting a message indicating: at least one of the two first frequency bands being anchor bands or the two second frequency bands being non-anchor bands, or at least one of the two first frequency bands being non-anchor bands or the two second frequency bands being anchor bands. For example, the communication management circuitry 1040 may be configured to implement one or more of the functions described below in relation to FIG. 11, including, e.g., block 1102.

In some aspects, the communication management circuitry 1040 may be configured for various functions, including, for example, refraining from receiving on the at least one frequency band during the switching period while switching from the one or more first frequency bands to the one or more second frequency bands. For example, the communication management circuitry 1040 may be configured to implement one or more of the functions described below in relation to FIG. 11, including, e.g., block 1106.

In some aspects, the communication management circuitry 1040 may be configured for various functions, including, for example, receiving a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands. For example, the communication management circuitry 1040 may be configured to implement one or more of the functions described below in relation to FIG. 11, including, e.g., block 1108.

In some aspects of the disclosure, the processor 1004 may include configuration information management circuitry 1042 configured for various functions, including, for example, transmitting, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission. For example, the configuration information management circuitry 1042 may be configured to implement one or more of the functions described below in relation to FIG. 11, including, e.g., block 1104.

In some aspects of the disclosure, the computer-readable storage medium 1006 may include communication management software/instructions 1060 configured for various functions, including, for example, transmitting a message indicating: at least one of the two first frequency bands being anchor bands or the two second frequency bands being non-anchor bands, or at least one of the two first frequency bands being non-anchor bands or the two second frequency bands being anchor bands. For example, the communication management software/instructions 1060 may be configured to implement one or more of the functions described below in relation to FIG. 11, including, e.g., block 1102.

In some aspects, the communication management software/instructions 1060 may be configured for various functions, including, for example, refraining from receiving on the at least one frequency band during the switching period while switching from the one or more first frequency bands to the one or more second frequency bands. For example, the communication management software/instructions 1060 may be configured to implement one or more of the functions described below in relation to FIG. 11, including, e.g., block 1106.

In some aspects, the communication management software/instructions 1060 may be configured for various functions, including, for example, receiving a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands. For example, the communication management software/instructions 1060 may be configured to implement one or more of the functions described below in relation to FIG. 11, including, e.g., block 1108.

In some aspects of the disclosure, the computer-readable storage medium 1006 may include configuration information management software/instructions 1062 configured for various functions, including, for example, transmitting, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission. For example, the configuration information management software/instructions 1062 may be configured to implement one or more of the functions described below in relation to FIG. 11, including, e.g., block 1104.

FIG. 11 is a flow chart illustrating an exemplary process 1100 for wireless communication in accordance with some aspects of the present disclosure. As described below, some or all illustrated features may be omitted in a particular implementation within the scope of the present disclosure, and some illustrated features may not be required for implementation of all embodiments. In some examples, the process 900 may be carried out by the network entity 1000 illustrated in FIG. 10. In some examples, the process 900 may be carried out by any suitable apparatus or means for carrying out the functions or algorithm described below.

At block 1102, in some aspects, the network entity 1000 may transmit a message indicating: at least one of the two first frequency bands being anchor bands or the two second frequency bands being non-anchor bands, or at least one of the two first frequency bands being non-anchor bands or the two second frequency bands being anchor bands. For example, the communication management circuitry 1040 shown and described above in connection with FIG. 10 may provide means for transmitting the message.

At block 1104, the network entity 1000 may transmit, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission. For example, the configuration information management circuitry 1042 shown and described above in connection with FIG. 10 via the communication management circuitry 1040 may provide means for transmitting the configuration information.

At block 1106, the network entity 1000 may refrain from receiving on the at least one frequency band during the switching period while switching from the one or more first frequency bands to the one or more second frequency bands. For example, the communication management circuitry 1040 shown and described above in connection with FIG. 10 may provide means for refraining from receiving on the at least one frequency band.

At block 1108, the network entity 1000 may receive a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands. For example, the communication management circuitry 1040 shown and described above in connection with FIG. 10 may provide means for receiving the set of uplink communications on the one or more second frequency bands.

In one configuration, the network entity 1000 for wireless communication includes means for transmitting, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, where a switching case pair is identified from the plurality of switching case pairs based on one or more first frequency bands of the plurality of frequency bands being switched to one or more second frequency bands of the plurality of frequency bands, and means for receiving a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands. In some aspects, the network entity 1000 may further include means for refraining from receiving on the at least one frequency band during the switching period while switching from the one or more first frequency bands to the one or more second frequency bands. In some aspects, the network entity 1000 may further include means for Transmit a message indicating: at least one of the two first frequency bands being anchor bands or the two second frequency bands being non-anchor bands, or at least one of the two first frequency bands being non-anchor bands or the two second frequency bands being anchor bands. In one aspect, the aforementioned means may be the processor(s) 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 3, and/or 5, and utilizing, for example, the processes and/or algorithms described herein in relation to FIG. 11.

The following provides an overview of several aspects of the present disclosure.

Aspect 1: A method of wireless communication by a user equipment (UE), comprising: identifying configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission; identifying a switching case pair from the plurality of switching case pairs based on one or more first frequency bands of the plurality of frequency bands being switched to one or more second frequency bands of the plurality of frequency bands; associating a switching period with at least one frequency band indicated by the configuration information based on the identified switching case pair, the at least one frequency band being at least one of the one or more first frequency bands or at least one of the one or more second frequency bands; switching from the one or more first frequency bands to the one or more second frequency bands during the switching period associated with the at least one frequency band; and transmitting a set of uplink communications on the one or more second frequency bands.

Aspect 2: The method of aspect 1, further comprising: receiving, from a network entity, the configuration information.

Aspect 3: The method of aspect 2, wherein the configuration information is received via at least one of a radio resource control (RRC) message or a media access control (MAC) control element (CE).

Aspect 4: The method of aspect 1, wherein the configuration information is preconfigured at the UE.

Aspect 5: The method of any of aspects 1 through 4, wherein the switching from the one or more first frequency bands to the one or more second frequency bands comprises: refraining from transmitting on the at least one frequency band during the switching period while switching from the one or more first frequency bands to the one or more second frequency bands.

Aspect 6: The method of any of aspects 1 through 5, wherein one or more transmit chains are associated with at least one of the one or more of the plurality of frequency bands indicated by each of the plurality of switching cases.

Aspect 7: The method of any of aspects 1 through 6, wherein the plurality of switching cases each further indicates one or more respective numbers of transmit chains respectively associated with the one or more of the plurality of frequency bands, and wherein the identifying the switching case pair from the plurality of switching case pairs comprises identifying the switching case pair from the plurality of switching case pairs based on the one or more first frequency bands being switched to the one or more second frequency bands and further based on one or more numbers of transmit chains respectively associated with the one or more first frequency bands and one or more numbers of transmit chains respectively associated with the one or more second frequency bands.

Aspect 8: The method of any of aspects 1 through 7, wherein the one or more respective frequency bands associated with the switching period for each of the plurality of switching case pairs comprise a single frequency band indicated by 2 bits.

Aspect 9: The method of any of aspects 1 through 7, wherein the one or more respective frequency bands associated with the switching period for each of the plurality of switching case pairs comprise two or more frequency bands indicated by 4 bits.

Aspect 10: The method of any of aspects 1 through 9, wherein the one or more first frequency bands and the one or more second frequency bands comprise at least one of the one or more first frequency bands comprising two first frequency bands or the one or more second frequency bands comprising two second frequency bands, and wherein the associating the switching period comprises associating the switching period with at least one of the two first frequency bands or at least one of the two second frequency bands in response to at least one of the two first frequency bands being anchor bands or the two second frequency bands being non-anchor bands, or at least one of the two first frequency bands being non-anchor bands or the two second frequency bands being anchor bands.

Aspect 11: The method of aspect 10, further comprising: receiving a message indicating at least one of the two first frequency bands being anchor bands or the two second frequency bands being non-anchor bands, or at least one of the two first frequency bands being non-anchor bands or the two second frequency bands being anchor bands, and wherein the associating the switching period comprises one of the following: associating the switching period either with the two first frequency bands or with the two second frequency bands, associating the switching period either with one of the two first frequency bands that has a lower subcarrier spacing among the two first frequency bands or with one of the two second frequency bands that has a lower subcarrier spacing among the two second frequency bands, associating the switching period either with one of the two first frequency bands that has a greater subcarrier spacing among the two first frequency bands or with one of the two second frequency bands that has a greater subcarrier spacing among the two second frequency bands, associating the switching period either with one of the two first frequency bands that has a lower frequency among the two first frequency bands or with one of the two second frequency bands that has a lower frequency among the two second frequency bands, associating the switching period either with one of the two first frequency bands that has a higher frequency among the two first frequency bands or with one of the two second frequency bands that has a higher frequency among the two second frequency bands, or associating the switching period either with one of the two first frequency bands that has a lower bandwidth among the two first frequency bands or with one of the two second frequency bands that has a lower bandwidth among the two second frequency bands.

Aspect 12: The method of aspect 10, wherein the one or more first frequency bands comprise the two first frequency bands and the one or more second frequency bands comprise a single second frequency band, or the one or more first frequency bands comprise a single first frequency band and the one or more second frequency bands comprise two second frequency bands, and wherein the associating the switching period comprises associating the switching period with the single second frequency band or the single first frequency band.

Aspect 13: The method of aspect 10, wherein the one or more first frequency bands comprise the two first frequency bands and the one or more second frequency bands comprise the two second frequency bands, and wherein the associating the switching period comprises associating the switching period with the two first frequency bands or the two second frequency bands.

Aspect 14: A user equipment (UE) comprising: a transceiver configured to communicate with a radio access network, a memory, and a processor communicatively coupled to the transceiver and the memory, wherein the processor and the memory are configured to perform any one of aspects 1 through 13.

Aspect 15: A UE configured for wireless communication comprising at least one means for performing any one of aspects 1 through 13.

Aspect 16: A non-transitory computer-readable storage medium having instructions for a UE thereon, wherein the instructions, when executed by a processing circuit, cause the processing circuit to perform any one of aspects 1 through 13.

Aspect 17: A method of wireless communication by a network entity, comprising: transmitting, to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission, wherein a switching case pair is identified from the plurality of switching case pairs based on one or more first frequency bands of the plurality of frequency bands being switched to one or more second frequency bands of the plurality of frequency bands; and receiving a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands.

Aspect 18: The method of aspect 17, wherein the configuration information is transmitted via at least one of a radio resource control (RRC) message or a media access control (MAC) control element (CE).

Aspect 19: The method of aspect 17 or 18, further comprising: refraining from receiving on the at least one frequency band during the switching period while switching from the one or more first frequency bands to the one or more second frequency bands.

Aspect 20: The method of any of aspects 17 through 19, wherein one or more transmit chains are associated with at least one of the one or more of the plurality of frequency bands indicated by each of the plurality of switching cases.

Aspect 21: The method of any of aspects 17 through 20, wherein the plurality of switching cases each further indicates one or more respective numbers of transmit chains respectively associated with the one or more of the plurality of frequency bands, and wherein the switching case pair is identified from the plurality of switching case pairs based on the one or more first frequency bands being switched to the one or more second frequency bands and further based on one or more numbers of transmit chains respectively associated with the one or more first frequency bands and one or more numbers of transmit chains respectively associated with the one or more second frequency bands.

Aspect 22: The method of any of aspects 17 through 21, wherein the one or more respective frequency bands associated with the switching period for each of the plurality of switching case pairs comprise a single frequency band indicated by 2 bits.

Aspect 23: The method of any of aspects 17 through 21, wherein the one or more respective frequency bands associated with the switching period for each of the plurality of switching case pairs comprise two or more frequency bands indicated by 4 bits.

Aspect 24: The method of any of aspects 17 through 23, wherein the one or more first frequency bands and the one or more second frequency bands comprise at least one of the one or more first frequency bands comprising two first frequency bands or the one or more second frequency bands comprising two second frequency bands, and wherein the associating the switching period comprises associating the switching period with at least one of the two first frequency bands or the two second frequency bands in response to at least one of the two first frequency bands being anchor bands or the two second frequency bands being non-anchor bands, or at least one of the two first frequency bands being non-anchor bands or the two second frequency bands being anchor bands:

Aspect 25: The method of aspect 24, further comprising: transmitting a message indicating at least one of the two first frequency bands being anchor bands or the two second frequency bands being non-anchor bands, or at least one of the two first frequency bands being non-anchor bands or the two second frequency bands being anchor bands, and wherein the switching period is associated based on one of the following: associating the switching period either with the two first frequency bands or with the two second frequency bands, associating the switching period either with one of the two first frequency bands that has a lower subcarrier spacing among the two first frequency bands or with one of the two second frequency bands that has a lower subcarrier spacing among the two second frequency bands, associating the switching period either with one of the two first frequency bands that has a greater subcarrier spacing among the two first frequency bands or with one of the two second frequency bands that has a greater subcarrier spacing among the two second frequency bands, associating the switching period either with one of the two first frequency bands that has a lower frequency among the two first frequency bands or with one of the two second frequency bands that has a lower frequency among the two second frequency bands, associating the switching period either with one of the two first frequency bands that has a higher frequency among the two first frequency bands or with one of the two second frequency bands that has a higher frequency among the two second frequency bands, or associating the switching period either with one of the two first frequency bands that has a lower bandwidth among the two first frequency bands or with one of the two second frequency bands that has a lower bandwidth among the two second frequency bands.

Aspect 26: The method of aspect 24, wherein the one or more first frequency bands comprise the two first frequency bands and the one or more second frequency bands comprise a single second frequency band, or the one or more first frequency bands comprise a single first frequency band and the one or more second frequency bands comprise two second frequency bands, and wherein the switching period is associated with the single second frequency band or the single first frequency band.

Aspect 27: The method of aspect 24, wherein the one or more first frequency bands comprise the two first frequency bands and the one or more second frequency bands comprise the two second frequency bands, and wherein the switching period is associated with with the two first frequency bands or the two second frequency bands.

Aspect 28: A base station comprising: a transceiver configured to communicate with a radio access network, a memory, and a processor communicatively coupled to the transceiver and the memory, wherein the processor and the memory are configured to perform any one of aspects 17 through 27.

Aspect 29: A base station configured for wireless communication comprising at least one means for performing any one of aspects 17 through 27.

Aspect 30: A non-transitory processor-readable storage medium having instructions for a base station thereon, wherein the instructions, when executed by a processing circuit, cause the processing circuit to perform any one of aspects 17 through 27.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIG. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIG. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication at a user equipment (UE), comprising:
identifying configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission;
identifying a switching case pair from the plurality of switching case pairs based on one or more first frequency bands of the plurality of frequency bands being switched to one or more second frequency bands of the plurality of frequency bands;
associating a switching period with at least one frequency band indicated by the configuration information based on the identified switching case pair, the at least one frequency band being at least one of the one or more first frequency bands or at least one of the one or more second frequency bands;
switching from the one or more first frequency bands to the one or more second frequency bands during the switching period associated with the at least one frequency band; and
transmitting a set of uplink communications on the one or more second frequency bands.

2. The method of claim 1, further comprising:
receiving, from a network entity, the configuration information.

3. The method of claim 2, wherein the configuration information is received via at least one of a radio resource control (RRC) message or a media access control (MAC) control element (CE).

4. The method of claim 1, wherein the configuration information is preconfigured at the UE.

5. The method of claim 1, wherein the switching from the one or more first frequency bands to the one or more second frequency bands comprises:
refraining from transmitting on the at least one frequency band during the switching period while switching from the one or more first frequency bands to the one or more second frequency bands.

6. The method of claim 1, wherein one or more transmit chains are associated with at least one of the one or more of the plurality of frequency bands indicated by each of the plurality of switching cases.

7. The method of claim 1, wherein the plurality of switching cases each further indicates one or more respective numbers of transmit chains respectively associated with the one or more of the plurality of frequency bands, and
wherein the identifying the switching case pair from the plurality of switching case pairs comprises identifying the switching case pair from the plurality of switching case pairs based on the one or more first frequency bands being switched to the one or more second frequency bands and further based on one or more numbers of transmit chains respectively associated with the one or more first frequency bands and one or more numbers of transmit chains respectively associated with the one or more second frequency bands.

8. The method of claim 1, wherein the one or more respective frequency bands associated with the switching period for each of the plurality of switching case pairs comprise a single frequency band indicated by 2 bits.

9. The method of claim 1, wherein the one or more respective frequency bands associated with the switching period for each of the plurality of switching case pairs comprise two or more frequency bands indicated by 4 bits.

10.-13. (canceled)

14. A user equipment (UE), comprising:
at least one processor;
at least one transceiver; and
at least one memory comprising instructions, wherein the at least one processor is configured to execute the instructions to cause the UE to:
identify configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission;
identify a switching case pair from the plurality of switching case pairs based on one or more first frequency bands of the plurality of frequency bands being switched to one or more second frequency bands of the plurality of frequency bands;
associate a switching period with at least one frequency band indicated by the configuration information based on the identified switching case pair, the at least one frequency band being at least one of the one or more first frequency bands or at least one of the one or more second frequency bands;
switch from the one or more first frequency bands to the one or more second frequency bands during the switching period associated with the at least one frequency band; and
transmit, via the at least one transceiver, a set of uplink communications on the one or more second frequency bands.

15. The UE of claim 14, wherein the one or more first frequency bands and the one or more second frequency bands comprise at least one of the one or more first frequency bands comprising two first frequency bands or the one or more second frequency bands comprising two second frequency bands, and
wherein the at least one processor configured to associate the switching period is configured to associate the switching period with at least one of the two first frequency bands or at least one of the two second frequency bands in response to at least one of the two first frequency bands being anchor bands or the two second frequency bands being non-anchor bands, or at least one of the two first frequency bands being non-anchor bands or the two second frequency bands being anchor bands.

16. The UE of claim 15, wherein the at least one processor is further configured to:
receive a message indicating at least one of the two first frequency bands being anchor bands or the two second frequency bands being non-anchor bands, or
at least one of the two first frequency bands being non-anchor bands or the two second frequency bands being anchor bands, and
wherein the at least one processor configured to associate the switching period is configured to perform one of the following:
associating the switching period either with the two first frequency bands or with the two second frequency bands,
associating the switching period either with one of the two first frequency bands that has a lower subcarrier spacing among the two first frequency bands or with one of the two second frequency bands that has a lower subcarrier spacing among the two second frequency bands,
associating the switching period either with one of the two first frequency bands that has a greater subcarrier spacing among the two first frequency bands or with one of the two second frequency bands that has a greater subcarrier spacing among the two second frequency bands,
associating the switching period either with one of the two first frequency bands that has a lower frequency among the two first frequency bands or with one of the two second frequency bands that has a lower frequency among the two second frequency bands, associating the switching period either with one of the two first frequency bands that has a higher frequency among the two first frequency bands or with one of the two second frequency bands that has a higher frequency among the two second frequency bands, or
associating the switching period either with one of the two first frequency bands that has a lower bandwidth among the two first frequency bands or with one of the two second frequency bands that has a lower bandwidth among the two second frequency bands.

17. The UE of claim 15, wherein the one or more first frequency bands comprise the two first frequency bands and the one or more second frequency bands comprise a single second frequency band, or the one or more first frequency bands comprise a single first frequency band and the one or more second frequency bands comprise two second frequency bands, and
wherein the at least one processor configured to associate the switching period is configured to associate the switching period with the single second frequency band or the single first frequency band.

18. The UE of claim 15, wherein the one or more first frequency bands comprise the two first frequency bands and the one or more second frequency bands comprise the two second frequency bands, and
wherein the at least one processor configured to associate the switching period is configured to associate the switching period with the two first frequency bands or the two second frequency bands.

19.-29. (canceled)

30. A network entity comprising:
at least one processor;
at least one transceiver; and
at least one memory comprising instructions,
wherein the at least one processor is configured to execute the instructions to cause the network entity to:
transmit, via the at least one transceiver and to a user equipment (UE), configuration information indicating one or more respective frequency bands associated with a switching period for each of a plurality of switching case pairs, each of the one or more respective frequency bands being one of a plurality of frequency bands including more than two frequency bands configured for uplink transmission, each of the plurality of switching case pairs being associated with two switching cases of a plurality of switching cases, the plurality of switching cases each indicating one or more of the plurality of frequency bands for uplink transmission,
wherein a switching case pair is identified from the plurality of switching case pairs based on one or more first frequency bands of the plurality of frequency bands being switched to one or more second frequency bands of the plurality of frequency bands; and
receive, via the at least one transceiver, a set of uplink communications on the one or more second frequency bands after switching from the one or more first frequency bands, wherein the one or more first frequency bands are switched to the one or more second frequency bands during a switching period associated with at least one frequency band indicated by the configuration information based on the identified switching case pair, the at least one frequency band being at least one of the one or more first frequency bands or at least one of the one or more second frequency bands.

31. The network entity of claim 30, wherein at least one of:
the configuration information is transmitted via at least one of a radio resource control (RRC) message or a media access control (MAC) control element (CE);
one or more transmit chains are associated with at least one of the one or more of the plurality of frequency bands indicated by each of the plurality of switching cases;
the one or more respective frequency bands associated with the switching period for each of the plurality of switching case pairs comprise a single frequency band indicated by 2 bits; or
the one or more respective frequency bands associated with the switching period for each of the plurality of switching case pairs comprise two or more frequency bands indicated by 4 bits.

32. The network entity of claim 30, wherein the at least one processor is configured to cause the network entity to:
refrain from receiving on the at least one frequency band during the switching period while switching from the one or more first frequency bands to the one or more second frequency bands.

33. The network entity of claim 30, wherein the plurality of switching cases each further indicates one or more respective numbers of transmit chains respectively associated with the one or more of the plurality of frequency bands, and
wherein the switching case pair is identified from the plurality of switching case pairs based on the one or more first frequency bands being switched to the one or more second frequency bands and further based on one or more numbers of transmit chains respectively associated with the one or more first frequency bands and one or more numbers of transmit chains respectively associated with the one or more second frequency bands.

34. The network entity of claim 30, wherein the one or more first frequency bands and the one or more second frequency bands comprise at least one of the one or more first frequency bands comprising two first frequency bands or the one or more second frequency bands comprising two second frequency bands, and
wherein the associating the switching period comprises associating the switching period with at least one of the two first frequency bands or the two second frequency bands in response to at least one of the two first frequency bands being anchor bands or the two second frequency bands being non-anchor bands, or at least one of the two first frequency bands being non-anchor bands or the two second frequency bands being anchor bands.

35. The network entity of claim 34, wherein the one or more first frequency bands comprise the two first frequency bands and the one or more second frequency bands comprise the two second frequency bands, and
wherein the switching period is associated with the two first frequency bands or the two second frequency bands.
